(19) United States
(12) Patent Application Publication
(10) Pub. No.: US 2017/0140423 A1
(43) Pub. Date: May 18, 2017

(54) SYSTEM AND METHOD FOR ADVERTISING AND DISTRIBUTING MESSAGES

(71) Applicant: Bonis Opus LLC, Harrington Park, NJ (US)

(72) Inventor: Elie Atalla, Harrington Park, NJ (US)

(21) Appl. No.: 15/352,367

(22) Filed: Nov. 15, 2016

Related U.S. Application Data
(60) Provisional application No. 62/256,193, filed on Nov. 17, 2015.

(51) Int. Cl. G06Q 30/02; H04L 12/58; H04L 29/08

(52) U.S. Cl. CPC G06Q 30/0249; H04L 67/26; G06Q 30/0273; G06Q 30/0246; G06Q 30/0277; H04L 51/32; G06Q 50/01

(57) ABSTRACT

A system and method provide advertising power to any person wishing to express an opinion, by distributing that message broadly to the public, regardless of the form of media or demographic groups, and provide a mechanism for supporting viewers to push it forward, and measures its success compared to competing messages. The invention provides access to advertising and dissemination of ideas to the masses of people, regardless of their membership in a social media or party or demography or geography or financial position. After the message is initiated, the invention allows for the public to support it by paying for additional views or clicks or advertisements which themselves allow for further support and so on. From that point forward, the message is propagated by the principle of survival of the fittest, where all messages are heard, but only the most widely accepted survive and grow.

### CROSS-REFERENCE TO RELATED APPLICATIONS

This application claims priority to U.S. Application No. 62/256,193, filed on Nov. 17, 2015, which is incorporated by reference in its entirety.

### BACKGROUND OF THE INVENTION

1. Field of the Invention

The present invention relates to publishing and advertising, and in particular to a system and method for advertising and distributing a message to multiple viewers.

2. Description of Prior Art

In 1976, Richard Dawkins published “The Selfish Gene,” in which he proposed that ideas and messages may be disseminated through people and cultures in a similar manner as biological genes, with ideas, messages, and other “memes” propagating, living, and dying by the principle of survival of the fittest.

People are limited in their ability to express their opinions and/or send messages to a mass audience. Users of social media are limited to communicating with other users of that same social media. Average individuals are often not widely heard because they are not popular or famous, or they cannot afford to buy advertising, or their message is only supported by groups or parties with broader agendas which may not prioritize their single issue. Furthermore, many are afraid to speak their mind lest their peers ridicule or outcast them because their ideas are not generally accepted.

Some broadcast and distribution systems require larger and larger payments as the message is distributed to a broader audience. Other systems limit distribution to users of the same social media platform, and users of those systems generally do not read messages from people they do not know or keep in contact with on a regular basis. Moreover, the users of those systems are not entirely anonymous.

Some other systems where parties or groups support particular issues and can themselves be supported are not anonymous, not easily and inexpensively created, supported and put into action, and not usually limited to a single issue or position on an issue because they are beholden to their largest contributors and broader membership. For example, non-profit organizations or political parties may be used to promote a message, however, these are not limited to a single message that is written and delivered in a single manner. Rather, supporters must support and accept the organization as a whole, including its overall mission, multiple messages, various means of raising funds, various means of spreading the message and limitations put on the organization by its own management, public perception and their largest, most influential contributors.

Currently, publishers of media and networks of media outlets will publish an individual's message in the form of advertisement, however, for most publishers there is a minimum spend that is required which the individual may not be able to afford, and/or an account must be established which the individual will find cumbersome and time-consuming, and most importantly, such publishers and networks do not provide a means for supporters to directly provide funding to the advertisements they see and agree with. In addition, if the individual provides a large amount of funding for a political message they may be required to register and disclose their identity so that they are no longer anonymous, whereas numerous small contributors, with no established organization are not required to do so by law.

The most popular method for individuals to distribute a message today is through social media, where they join a membership organization and are able to post and share messages through that media. However, there are major limitations and differences. First, social media is not anonymous, which limits a person's ability to freely express messages. Second, these are, as the name suggests, “social” organizations and therefore are limited to the groups and communities that are formed by individuals connecting, following, friending and/or otherwise making contact with other individuals of like mind and similar opinions and beliefs. Therefore, individuals only have access to other individuals within their circle of friends or followers. Famous individuals are an exception in that they have many followers and can be heard via social media across a wide variety of groups and individuals, but this does not apply to the vast majority of social media participants. Finally, social media participants are themselves limited to their own social media platforms because they do not have a means to send messages to people that are not enrolled on that same platform.

### OBJECTS AND SUMMARY OF THE INVENTION

The following presents a simplified summary of some embodiments of the invention in order to provide a basic understanding of the invention. This summary is not an extensive overview of the invention. It is not intended to identify key/critical elements of the invention or to delineate the scope of the invention. Its sole purpose is to present some embodiments of the invention in a simplified form as a prelude to the more detailed description that is presented later.

The present invention gives an individual direct access to free speech through anonymous advertising at a low cost, while providing the opportunity to be heard at the same scale as a large, well-funded organization because the message in the advertisement can be supported by any other individual that views and responds to it. The mechanism enabling support also ensures that the most popular messages are automatically provided with a growing advertising budget because the invention immediately adds newly contributed funds to the advertisements' budgets. The updated budgets are then used to automatically generate a new order to buy more advertising space for those messages. The invention also provides supporters access to the most current statistics on the advertisements' distribution, reach, response rates and popularity.

The invention includes a method comprising: creating a message having an associated value; publishing the message; monitoring the manner in which the message is accessed; adjusting the associated value of the message based on the manner of access of the message; and controlling further publication of the message based on the adjusted associated value. The associated value is an advertising budget; adjusting the associated value includes increasing or decreasing the advertising budget based on the number of views of the message; and controlling further publication includes increasing or decreasing the forms of media for disseminating the message based on an increased or decreased budget, respectively.

Alternatively, the associated value is a measure of support for the message; adjusting the associated value includes increasing or decreasing the measure of support based on the number of views of the message; and controlling further publication includes increasing or decreasing the forms of media for disseminating the message based on an increased or decreased measure of support, respectively. The measure of support is selected from the group consisting of the number of computer-based clicks on a displayed version of the message, the number of communications with contact information in the message, the number of likes of the message in social media, the number of approvals of the message in social media, the number of positive comments on the message in social media, and the amounts of payments contributed to contact information of the message to show support for the message.

The publishing includes posting the message to a website, and may include advertising the message in an ad. The method also includes screening the created message, prior to publication, by an administrator.

A non-transitory computer-readable medium is also included having instructions stored thereon which, when executed by a processor, cause the processor to perform: creating a message having an associated value; publishing the message; monitoring the manner in which the message is accessed; adjusting the associated value of the message based on the manner of access of the message; and controlling further publication of the message based on the adjusted associated value. The associated value is an advertising budget; adjusting the associated value includes increasing or decreasing the advertising budget based on the number of views of the message; and controlling further publication includes increasing or decreasing the forms of media for disseminating the message based on an increased or decreased budget, respectively.

Alternatively, the associated value is a measure of support for the message; adjusting the associated value includes increasing or decreasing the measure of support based on the number of views of the message; and controlling further publication includes increasing or decreasing the forms of media for disseminating the message based on an increased or decreased measure of support, respectively. The measure of support is selected from the group consisting of the number of computer-based clicks on a displayed version of the message, the number of communications with contact information in the message, the number of likes of the message in social media, the number of approvals of the message in social media, the number of positive comments on the message in social media, and the amounts of payments contributed to contact information of the message to show support for the message.

The publishing includes posting the message to a website, and may include advertising the message in an ad. The medium may include screening the created message, prior to publication, by an administrator.

A system is also included comprising: a server connected to a communications network, the server having a processor and a memory, the memory storing a plurality of messages with associated values, the processor for: creating a message having an associated value; publishing the message over the communications network; monitoring the manner in which the message is accessed; adjusting the associated value of the message based on the manner of access of the message; and controlling further publication of the message based on the adjusted associated value. The associated value is an advertising budget; adjusting the associated value includes increasing or decreasing the advertising budget based on the number of views of the message; and controlling further publication includes increasing or decreasing the forms of media for disseminating the message based on an increased or decreased budget, respectively.

Alternatively, the associated value is a measure of support for the message; adjusting the associated value includes increasing or decreasing the measure of support based on the number of views of the message; and controlling further publication includes increasing or decreasing the forms of media for disseminating the message based on an increased or decreased measure of support, respectively. The measure of support is selected from the group consisting of the number of computer-based clicks on a displayed version of the message, the number of communications with contact information in the message, the number of likes of the message in social media, the number of approvals of the message in social media, the number of positive comments on the message in social media, and the amounts of payments contributed to contact information of the message to show support for the message.

The publishing includes posting the message to a website, and may also include advertising the message in an ad.

The present invention provides access to advertising and dissemination of ideas to the masses of people, regardless of their membership in a social media or party or demography or geography or financial position. After the message is initiated, the invention allows for the public to support it by paying for additional views or clicks or advertisements which themselves allow for further support and so on. Any message can be created and can be used to address any topic, no matter how narrow, or mundane, or controversial because the message is anonymous and created by the user. From that point forward its survival of the fittest, where all messages are heard, but only the most widely accepted survive and grow.

Supporters can view the message's statistics on the website, support the message, support alternative messages, or create their own. They can also sort and view messages by topic or issue and support the ones they agree with.

Further, the invention will have a monitoring function, restricting bad behavior, but also restricting lies and misleading statements. Messages are not permitted to present information as fact unless it is sourced and substantiated.

The invention provides a standardized template, software and interface for creating image advertisements from text messages; an automated system for adding necessary disclaimers and adding provided sources for factual claims; an interface for administrators to quickly access messages and their claimed source through a web URL to the information cited in the message; the generation of a message with a destination URL (the web page users are directed to after clicking on the ad) that includes a means to directly support that single message with additional funding; the additional funding is immediately added to the ad's budget and displayed as such; the low cost of advertising (as opposed to large political contributions which must be reported) and the non-public provision of support (nobody is forwarding and re-sending a message from their own social media accounts) allows for a uniquely anonymous form of personal expression, which, although anonymous in source, is very clearly democratic in nature and a true reflection of public sentiment. In other words, people only “put their money where their mouth is;” and instant feedback is provided by the public viewing messages because the most popular messages will be clicked on and supported, and the results are displayed for all users to see. Success of all messages can be compared to each other and tracked over time.

The present invention is self-sustaining through click and support mechanism; low cost to create; low cost to support; available to individuals without advertising knowledge; no overhead cost, approval process, political complications and regulatory limitations of an organization; not limited to a single social media platform; broad reach is not limited to famous people with many followers (social media); supported by individuals in a direct, specific and efficient manner; and anonymous speech unhindered by public opinion.

### BRIEF DESCRIPTION OF THE DRAWINGS

The foregoing summary, as well as the following detailed description of presently preferred embodiments of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown.

In the drawings:

FIG. 1 is a schematic of the system of the present invention; and

FIG. 2 is a flowchart of operation of the method of the present invention.

To facilitate an understanding of the invention, identical reference numerals have been used, when appropriate, to designate the same or similar elements that are common to the figures. Further, unless stated otherwise, the features shown in the figures are not drawn to scale, but are shown for illustrative purposes only.

### DETAILED DESCRIPTION OF THE PREFERRED EMBODIMENTS

Certain terminology is used in the following description for convenience only and is not limiting. The article “a” is intended to include one or more items, and where only one item is intended the term “one” or similar language is used. Additionally, to assist in the description of the present invention, words such as top, bottom, upper, lower, front, rear, inner, outer, right and left are used to describe the accompanying figures. The terminology includes the words above specifically mentioned, derivatives thereof, and words of similar import.

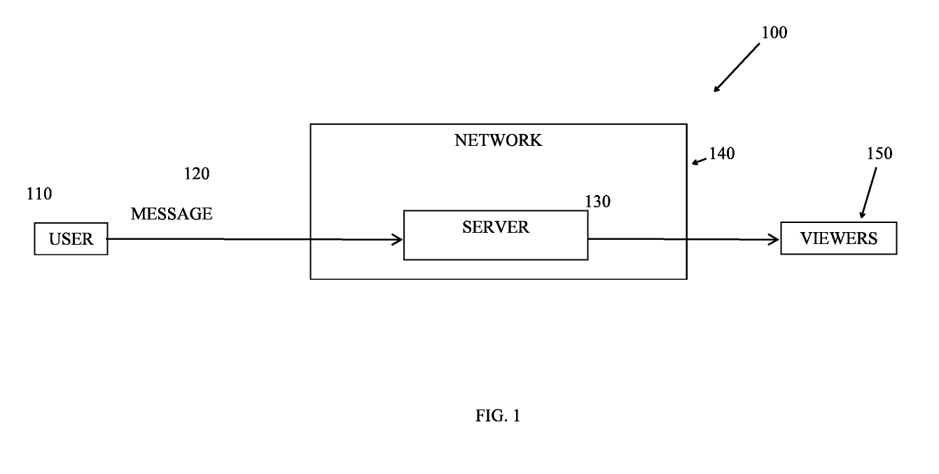

As shown in FIG. 1, the system 100 of the present invention allows a user 110 to send a message 120 to a server 130 which is part of or in communication with a network 140. For example, the server 130 may be a web server and the network 140 may be the World Wide Web or the Internet as a whole, with the server 130 maintaining a website for displaying the message 120, allowing viewers 150 to view or receive the message in the form of an advertisement, an e-mail, or other technologies known in the art for a viewer 150 to receive the message 120.

In an example embodiment, the server 130 includes a processor and memory known in the art for receiving, storing, processing, and outputting one or more of the messages 120. For example, the server 130 may include an SQL database for storing the messages and associated data, including the identity of the user 110, or otherwise an indication of anonymity of the user 110, as well as data values for the message, storing values for a budget, the number of computer-based clicks on a displayed version of the message 120, the number of communications with contact information in the message 120, the number of likes of the message 120 in social media, the number of approvals of the message 120 in social media, the number of positive comments on the message 120 in social media, and the amounts of payments contributed to contact information of the message 120 to show support for the message 120. Even though the driving force behind the increase in budget and breadth of distribution of the message 120 is primarily mass support in the form of contributions, the other factors mentioned above could be used to distribute budget and propagation of a particular advertisement or message.

The processor of the server 130 includes hardware, firmware, and/or software executing instructions. For example, the server 130 may include a non-transitory computer-readable medium having such instructions stored thereon which, when executed by the processor of the server 130, cause the processor to perform the method of the present invention.

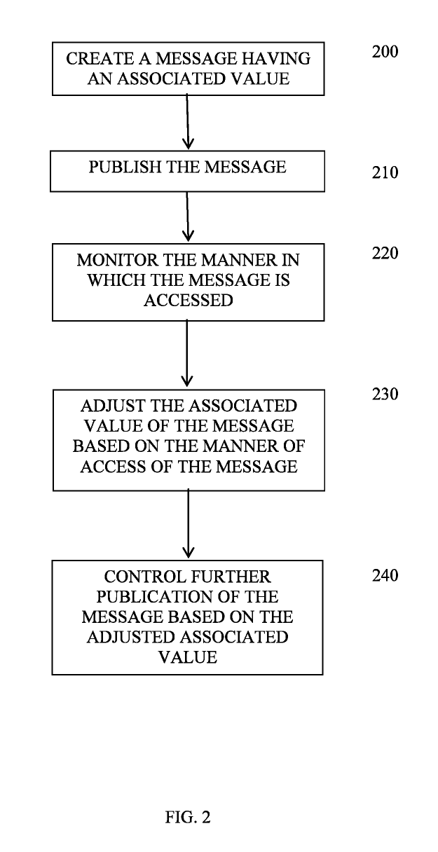

As shown in FIG. 2, the method of the present invention generally includes creating 200 a message having an associated value; publishing 210 the message; monitoring 220 the manner in which the message is accessed; adjusting 230 the associated value of the message based on the manner of access of the message; and controlling 240 further publication of the message based on the adjusted associated value. In one embodiment, the associated value is an advertising budget; adjusting the associated value includes increasing or decreasing the advertising budget based on the number of views of the message; and controlling further publication includes increasing or decreasing the forms of media for disseminating the message based on an increased or decreased budget, respectively.

Alternatively, the associated value is a measure of support for the message; adjusting the associated value includes increasing or decreasing the measure of support based on the number of views of the message; and controlling further publication includes increasing or decreasing the forms of media for disseminating the message based on an increased or decreased measure of support, respectively. The measure of support is selected from the group consisting of the number of computer-based clicks on a displayed version of the message, the number of communications with contact information in the message, the number of likes of the message in social media, the number of approvals of the message in social media, the number of positive comments on the message in social media, and the amounts of payments contributed to contact information of the message to show support for the message.

The publishing includes posting the message to a website maintained by the server 130 and accessible to viewers 150 accessing the network 140, and may include advertising the message 120 in an ad. The method also includes screening the created message, prior to publication, by an administrator, for example, to prevent messages 120 having profanity, distasteful and/or illegal content, content violating copyright and trademark laws, etc.

In operation, the present invention is generally executed in the following steps:

Step 1: Person A creates a message, limited to a number of characters, and buys views or clicks in any quantity they wish.

Step 2: The message is initially posted on the site at no cost and is allowed to garner support from other users for a period of time. Thereafter a budget of available funds is determined and the advertising of the message is initiated by system. For example the message will be seen as a standalone message by a certain number of visitors to a site or until another person clicks on the ad. The ad includes the number of supporters and provides a method for a viewer to click or call or otherwise provide support for that message.

Step 3: Person B clicks on a message they agree with and are then directed to the systems website where they can view data ad history on that message, they can pay for additional views or clicks of that message, or they can create a different message or support a different message.

Step 4: The message is advertised in a rotating group of messages until its support and associated funds are exhausted. If the support continues to grow, additional ads can be placed in a systematic hierarchy of different media. In some cases, a super popular ad can end up with enough support to create a television commercial for example.

Step 5: Person A can return to the site any time, view how the message was advertised and monitor the success of their message; thereby receiving validation or not. They may pay for additional advertising of the message, however, contributions will be limited to a certain sum to prevent any single person from disseminating a message which in fact does not have much support.

The present invention provides a means for creating a message, paying for a message and advertising the message. A website is used to allow for users to establish an account (at no cost) and to create a message. The website provides a message builder which limits the options and format of the advertisement. The website also collects payment from the initial and subsequent supporters so their accounts are required to be linked to a payment method.

The website of the present invention provides a standardized way to create and distribute a message. The message may be limited to a certain number of characters and/or it may not be allowed to contain art or images. Standardization makes the placement of ads a normalized procedure with a known size and known content format. Also, the present invention can create a package of messages which are similar in format but standardized in size and limited to a certain number of characters to ensure readability. The user will be able to produce messages on different color backgrounds, using different fonts and a limited number of sizes, etc.

As an example, an individual that feels strongly about a particular issue but is afraid to voice their opinion or does not have the means to advertise it can go to the invention's website, create an account, write and format a message (for example: “Please vote for leaders that support term limits in Congress”), and then enter a payment method and purchase $1 or more of advertising time. Their message will then be posted to the website for a period of time to allow others to add support, and will periodically be put into a cue for advertising campaigns. From that point forward the users are all other people that view and want to support the message. Those users will click on the ad (for example) and go to the page where they can view information on the program, the message and be allowed to pay for additional support.

Once created, the message undergoes a review by the website operators to screen out any inappropriate or unsubstantiated claims or statements. However, the system of the present invention also allows for viewers to respond to the message and provide their own support. In addition, requirements for sourcing and substantiating statements of fact can be loosened or tightened. An optional addition is to establish a system of fact checking whereby fact checkers are encouraged to volunteer their time after being qualified (e.g. based on education, experience, neutrality and background checks). They may be rewarded with credits towards supporting their favorite messages; and the quality of their reviews can be measured and tracked for accuracy. This additional component will allow for more general statements to be made without specific citations or sources provided, however, the submitter or supporters may have to provide material which supports their position so that the fact checker can evaluate it.

The system of the present invention includes a method to package messages and distribute them to advertising companies and to instruct them on how they are to be displayed and for how long. The website of the present invention includes a section where each message's advertising history, viewers, supporters, and statistics are available. That same section may be used to allow a user to add support by buying additional advertising for that message.

In addition, a method of categorizing, displaying and searching for messages is established and displayed in an “all messages” section. Data feeds can be established and provided in real time.

The amount of support received (money paid into the budget) will determine the amount of exposure the ad will receive. If the ad receives more exposure it may then garner more support, and the cycle may repeat indefinitely, this making the advertisement a “self-propelling message.” The idea or thought or opinion will be judged and supported in its own merit, not by the messenger's status or the attractiveness of a commercial or any other superfluous factors.

In Step 1, where Person A creates a message may in fact be a later step for Person B who then goes to the website and decides to create and advertise a competing or opposing message. In other words, the system allows for a cycle of individuals, creating their own messages, viewing other messages, tracking support for their own message and providing support for other messages, perhaps in different topic areas. Topics or categories are used on the website to organize messages and to allow users easy access to their favorites, such as sports, entertainment, local politics, etc. The creator of the message will have the opportunity to categorize their message themselves and to choose their geographic distribution.

Messages are created and initially advertised in a limited budget. If that budget grows because additional viewers support the message, it may then be continued in the advertising medium used. If the budget grows to different levels, then the type of advertisement (e.g. banner, side ad, billboard, direct mail, radio advertisement, television, etc.) may change according to a predetermined list and a logical progression.

Additionally, as mentioned previously, the invention can be used to create and distribute messages to mass audiences or target audiences. It can also be used to reach limited geographic areas such as particular counties. Methods for expanding advertising campaigns may differ and the types of media used, such as direct mail, are optional. Finally, it can be used to advertise messages in any medium, such as billboards or radio.

The system of the present invention supports multiple, interdependent steps and processes, described below as Sections 1-6.

Section 1: Entry

Users may enter directly through the site's Home Page and then choose to view, support, create or learn more about the site or the messages. Alternatively, users would enter the site after clicking on any of the active advertisements displayed on a large network of public websites which are somewhat randomly selected to encourage broad distribution of the messages. This is called the “Click-Through Entry” and will provide a user with a short explanation of the system, an image of the ad they clicked on and options to support the ad, view other ads or create their own message/ad.

Section 2: Discovery

Users can view all active messages or filter for specific topics or “categories” of interest. Once they see a message they are interested in, they may then choose to click to get more information about it or click to add funds to its budget. There is also a How it Works section which explains the system, process, purpose and important rules which outline disallowed content, such as illegal or offensive messaging.

Section 3: Join

Users that choose to fund a message or create a new message will then be directed to either a Log-In page if they are already members, or a Sign-Up page if they are not. As per usual, contact, username and payment information is saved here and a new record is established in the Customer Database.

Section 4: Action

There are two primary actions supported by the technology: creating messages/advertisements and supporting messages/advertisements.

In the first function, a user can type their message, format the background color, font colors, font sizes and font styles. These are done in a template that allows some creative leeway but maintains a standardized input that is predictable enough to be automatically translated into an advertising image, which may also be previewed in its final form. Based on the content of the message, disclaimers may be added (for example, for political messages a disclaimer disavowing association with a candidate or committee is legally required in the United States). Sources used may also be provided for inclusion in the advertisement in a standard format. And, in support of a review and approval process, links to the sources of the claimed facts are provided. In addition, the user can decide which category his/her message best fits under and they may choose which geographic area they would like the message distributed. For example, a local issue may be addressed in a specific county, while a national issue may be addressed in an ad with national distribution. Finally, payment is submitted by the user. Here, the payment is authorized but not captured, pending approval. All details of a newly created message are saved to a Message Database and the generated image is saved to an Image Repository. In addition, an email notifies user of the new message having been created and next steps.

The second function, allows a user to support a message by adding funds to the ad's budget. Funds are charged to a credit card, bank card, other payment medium, or deducted from a credit balance, if any. After an administration fee is subtracted, the majority of contributed funds are immediately added to the ad's budget. This is displayed on the home page of the website, on the message's information page and saved to the message database. Likewise, an email is sent to the user to confirm and thank them for their support.

Section 5: Follow

In addition to creating and supporting messages, users can also track the messages' progress, funding and popularity which is provided on a Message Info page for each message created. These pages also give the user a perspective on number of views and clicks over time (e.g. from week to week or since inception).

There is also a personal My Account section where a user can view/edit their contact and payment information, view and support their own messages and/or view and support all messages they have supported in the past. These would link back to Action pages above and/or update Customer and Message databases appropriately.

Section 6: Admin

Back-end administration uses a message database to populate an administrator's interface with information required to approve or disapprove messages submitted. After verifying that messages are within the operating rules defined by the How it Works section, messages are approved and made ready for submission to the ad network.

Periodically (e.g. daily), data on currently running advertisements is collected from the ad network that is being used by the system. This includes information on the number of views/impressions, clicks, click through rates and cost and is uploaded to the website for review by members and message supporters. In addition, all new and existing advertisements/messages are downloaded from the website as pre-formatted images and in a comma delimited database format which is uploaded in a bulk operation to the ad network. This “orders file” provides instructions for new advertisements, including their budget and target distribution and any changes or updates to existing budgets based on prior spend (downloaded earlier) and new contributions (received from users since the last update). Alternatively, both of these data transfer operations may be completed using a direct, fully automated integration using a standard application program interface (API) between the invention and the ad network being used to distribute the advertisements.

Once confirmed by the ad network and the ad starts running, the customer is charged, and notified of their new message being approved.

The Customer Database is also available to administrators in order to monitor and communicate with customers and to make periodic changes to customer information if the customer is unable to do so or if certain limitations must be put on a customer for violation of rules or non-payment. In addition, promotional activities which may result in free credits or coupons may be conducted through this interface.

The system and method of the present invention could have alternative configurations. For example, the current configuration and use provides for a limit on the amount any individual can contribute per month. This is set low enough to prevent wealthier individuals from having an inordinate or unfair advantage with regards to messages supported or distributed. In addition, the minimum contributions are set very low to enable the most number of people to participate in the process. Both of these constraints may be added, removed or adjusted.

The current configuration is also very focused on the individual and individual messages, however, the same technology can be offered to organizations which wish to start a self-sustaining advertisement. Such an ad can offer them superior efficiency to that of fund raising from membership, administrative processes and manual advertising. Instead, the invention would allow organizations, such as charities or public awareness campaigns, a way to generate support and distribute their message without having to add new members, collect membership information, report membership information, collect funding, distribute funding and account for funding.

The present invention can be used with any advertising medium (e.g. voice, video, text ads) that can be customized by the customer/user and that can be altered by the invented system to provide a mechanism for response and funding. For example, a video that provides a link to a website or a voice message that provides a code that can be spoken into a device and will be recognized using voice recognition or similar software.

The present invention can also be made to include a method of categorization that matches individual messages on one side of an issue to individual messages on the other. Once organized and displayed in this manner, users will be able to click on any ad, regardless of the ad's message, and know that once they arrive at the website they will likely have the choice of supporting that ad or a directly opposed one.

In addition, as mentioned above, requirements for sourcing and substantiating statements of fact can be loosened or tightened. A related option may include a system of fact checking whereby fact checkers are encouraged to volunteer their time after being qualified (e.g. based on education, experience, neutrality and background checks) and would serve as a substitute for direct sources being required. They may be rewarded with credits towards supporting their favorite messages; and the quality of their reviews can be measured and tracked for accuracy.

The advertisements can also be more complex and customizable with regard to content, size, distribution, demographics and other audience targeting methods. Along with such capability, the user may be offered a variety of pre-designed graphics, phrases, images and other content that they can use to help quickly customize more complex ads which supports their message in a variety of ways. Such components can be offered along with the option for the user to upload their own images or graphics, making the ad more interesting, poignant and/or more effective.

The present invention solves the problems in the prior art of people being limited in their ability to express their opinions and/or send messages to a mass audience; users of social media are limited to other users of that same social media; average individuals are often not widely heard because they are not popular or famous, or they can't afford to buy advertising, or their message is only supported by groups or parties with broader agendas which may not prioritize their single issue; and many are afraid to speak their mind lest their peers ridicule or outcast them because their ideas are not generally accepted.

First, messages can be created by anyone using the business' website.

Second, the message can be distributed to anyone in the general public, initially using a broad cross section of popular websites, then print, radio and television as the budget grows and can support the wider distribution.

Third, messages are not limited to a single platform, such as Facebook or Twitter, both in their creation and their audience.

Fourth, the individual's popularity or fame is not relevant. Rather, the popularity of the message itself is the true driving force behind it's wider distribution by supporters.

Fifth, access is provided for a nominal fee (e.g. $1.00) so the financial barrier to buying advertising is eliminated, and a cap on spend ensures that the system remains democratic and not excessively influenced by wealthier individuals.

Sixth, the program allows a single issue to be spotlighted, rather than an entire agenda or “party platform” which users may not agree with entirely.

Finally, the option to remain anonymous makes free speech truly free because people can express their opinions without fear of repercussions from disagreeing peers.

The present invention differs from what currently exists. The invention improves upon existing methods of communication because it is broadly accessible (anyone with a dollar and access to the internet), ensures broad distribution and gives all voices a chance to be heard and agreed with. If the latter occurs, the process allows supporters to provide additional funds for more paid advertising. This method is not dependent on the popularity or fame of the message's supporters, nor their individual wealth, nor any single platform, nor freedom from ridicule or negative repercussions.

The systems of the prior art do not work well because they are not designed for giving individuals a voice. They are primarily designed for advertising business products and services, not opinions and beliefs. Parties and charities which do focus on opinions and beliefs are controlled by their largest contributors and their fear of alienating any constituent group; and they offer agendas or party platform which is a bundled offering of support for a variety of issues which an individual may not agree with.

The invention provides access to advertising and dissemination of ideas to the masses of people, regardless of their membership in a social media or party or demography or geography or financial position. After the message is initiated, the invention allows for the public to support it by paying for additional views or clicks or advertisements which themselves allow for further support and so on. Any message can be created (barring profanity or other distasteful or illegal content by an administrator) and can be used to address any topic, no matter how narrow, or mundane, or controversial because the message is anonymous and created by the user. From that point forward its survival of the fittest, where all messages are heard, but only the most widely accepted survive and grow.

Supporters can view the message's statistics on the website, support the message, support alternative messages, or create their own. They can also sort and view messages by topic or issue and support the ones they agree with.

Further, the present invention includes a monitoring function, restricting bad behavior, but also lies and misleading statements. Messages are not permitted to present information as fact unless it is sourced and substantiated.

Also, the output of the present invention is a package of messages which are similar in format but standardized in size and limited to a certain number of characters to ensure readability. The user is able to produce messages on different color backgrounds, using different fonts and a limited number of sizes, etc.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method comprising:
creating a message having an associated value;
publishing the message;
monitoring the manner in which the message is accessed;
adjusting the associated value of the message based on the manner of access of the message; and
controlling further publication of the message based on the adjusted associated value.

2. The method of claim 1, wherein the associated value is an advertising budget;
adjusting the associated value includes increasing or decreasing the advertising budget based on the number of views of the message; and
controlling further publication includes increasing or decreasing the forms of media for disseminating the message based on an increased or decreased budget, respectively.

3. The method of claim 1, wherein the associated value is a measure of support for the message;
adjusting the associated value includes increasing or decreasing the measure of support based on the number of views of the message; and
controlling further publication includes increasing or decreasing the forms of media for disseminating the message based on an increased or decreased measure of support, respectively.

4. The method of claim 3, wherein the measure of support is selected from the group consisting of the number of computer-based clicks on a displayed version of the message, the number of communications with contact information in the message, the number of likes of the message in social media, the number of approvals of the message in social media, the number of positive comments on the message in social media, and the amounts of payments contributed to contact information of the message to show support for the message.

5. The method of claim 1, wherein the publishing includes posting the message to a website.

6. The method of claim 1, wherein the publishing includes advertising the message in an ad.

7. The method of claim 1, further comprising:
screening the created message, prior to publication, by an administrator.

8. A non-transitory computer-readable medium having instructions stored thereon which, when executed by a processor, cause the processor to perform:
creating a message having an associated value;
publishing the message;
monitoring the manner in which the message is accessed;
adjusting the associated value of the message based on the manner of access of the message; and
controlling further publication of the message based on the adjusted associated value.

9. The computer-readable medium of claim 8, wherein the associated value is an advertising budget;
adjusting the associated value includes increasing or decreasing the advertising budget based on the number of views of the message; and
controlling further publication includes increasing or decreasing the forms of media for disseminating the message based on an increased or decreased budget, respectively.

10. The computer-readable medium of claim 8, wherein the associated value is a measure of support for the message;
adjusting the associated value includes increasing or decreasing the measure of support based on the number of views of the message; and
controlling further publication includes increasing or decreasing the forms of media for disseminating the message based on an increased or decreased measure of support, respectively.

11. The computer-readable medium of claim 10, wherein the measure of support is selected from the group consisting of the number of computer-based clicks on a displayed version of the message, the number of communications with contact information in the message, the number of likes of the message in social media, the number of approvals of the message in social media, the number of positive comments on the message in social media, and the amounts of payments contributed to contact information of the message to show support for the message.

12. The computer-readable medium of claim 8, wherein the publishing includes posting the message to a website.

13. The computer-readable medium of claim 8, wherein the publishing includes advertising the message in an ad.

14. The computer-readable medium of claim 8, further comprising:
screening the created message, prior to publication, by an administrator.

15. A system comprising:
a server connected to a communications network, the server having a processor and a memory, the memory storing a plurality of messages with associated values, the processor for:
creating a message having an associated value;
publishing the message over the communications network;
monitoring the manner in which the message is accessed;
adjusting the associated value of the message based on the manner of access of the message; and
controlling further publication of the message based on the adjusted associated value.

16. The system of claim 15, wherein the associated value is an advertising budget;
adjusting the associated value includes increasing or decreasing the advertising budget based on the number of views of the message; and
controlling further publication includes increasing or decreasing the forms of media for disseminating the message based on an increased or decreased budget, respectively.

17. The system of claim 15, wherein the associated value is a measure of support for the message;
adjusting the associated value includes increasing or decreasing the measure of support based on the number of views of the message; and
controlling further publication includes increasing or decreasing the forms of media for disseminating the message based on an increased or decreased measure of support, respectively.

18. The system of claim 17, wherein the measure of support is selected from the group consisting of the number of computer-based clicks on a displayed version of the message, the number of communications with contact information in the message, the number of likes of the message in social media, the number of approvals of the message in social media, the number of positive comments on the message in social media, and the amounts of payments contributed to contact information of the message to show support for the message.

19. The system of claim 15, wherein the publishing includes posting the message to a website.

20. The system of claim 15, wherein the publishing includes advertising the message in an ad.
